(19) United States
(12) Patent Application Publication
(10) Pub. No.: US 2013/0058099 A1
(43) Pub. Date: Mar. 7, 2013

(54) High Intensity Light Source with Interchangeable Optics

(71) Applicants: Frank Shum, Sunnyvale, CA (US); Clifford Jue, Santa Cruz, CA (US)

(72) Inventors: Frank Shum, Sunnyvale, CA (US); Clifford Jue, Santa Cruz, CA (US)

(73) Assignee: Soraa, Inc., Fremont, CA (US)

(21) Appl. No.: 13/480,767

(22) Filed: May 25, 2012

Related U.S. Application Data
(60) Provisional application No. 61/530,832, filed on Sep. 2, 2011.

(51) Int. Cl. F21V 29/00; F21V 13/04

(52) U.S. Cl. 362/294

(57) ABSTRACT

An illumination source configured to output light having a user-modifiable beam characteristic includes a LED light unit for providing a light output in response to an output driving voltage, a driving module for receiving an input driving voltage for providing the output driving voltage to the LED light unit, a heat sink coupled to the LED light unit for dissipating heat produced by the LED light unit and the driving module, a reflector coupled to the heat sink for receiving the light output, for outputting a light beam having a first beam characteristic, and a lens coupled to the heat sink for receiving the light beam having the first beam characteristic and for outputting a light beam having a second beam characteristic, wherein the lens is selected by the user to achieve the second beam characteristic, and wherein the lens is coupled to the heat sink by the user.

The present application claims priority to U.S. Provisional Application No. 61/530,832, filed on Sep. 2, 2011, which is incorporated herein by reference for all purposes.

### TECHNICAL FIELD

The present invention relates to lighting. More specifically, the present invention relates to user-configurable high efficiency lighting sources.

### BACKGROUND

The era of the Edison vacuum light bulb will be coming to an end soon. In many countries and in many states, common incandescent bulbs are becoming illegal, and more efficient lighting sources are being mandated. Some of the alternative light sources currently include fluorescent tubes, halogen, and light emitting diodes (LEDs). Despite the availability and improved efficiencies of these other options, many people have still been reluctant to switch to these alternative light sources.

The inventors of the present believe that there are several key reasons why consumers have been slow to adopt the newer technologies. One such reason is the use of toxic substances in the lighting sources. As an example, fluorescent lighting sources typically rely upon mercury in a vapor form to produce light. Because the mercury vapor is considered a hazardous material, spent lamps cannot simply be disposed of at the curbside but must be transported to designated hazardous waste disposal sites. Additionally, some fluorescent tube manufacturers go so far as to instruct the consumer to avoid using the bulb in more sensitive areas of the house such as bedrooms, kitchens, and the like.

The inventors of the present invention also believe that another reason for the slow adoption of alternative lighting sources is the low performance compared to the incandescent light bulb. As an example, fluorescent lighting sources often rely upon a separate starter or ballast mechanism to initiate the illumination. Because of this, fluorescent lights sometimes do not turn on “instantaneously” as consumers expect and demand. Further, fluorescent lights typically do not immediately provide light at full brightness, but typically ramp up to full brightness within an amount of time (e.g. 30 seconds). Further, most fluorescent lights are fragile, are not capable of dimming, have ballast transformers that can emit annoying audible noise, and can fail in a shortened period of time if cycled on and off frequently. Because of this, fluorescent lights do not have the performance consumers require.

Another type of alternative lighting source more recently introduced relies on the use of light emitting diodes (LEDs). LEDs have advantages over fluorescent lights including the robustness and reliability inherent in solid state devices, the lack of toxic chemicals that can be released during accidental breakage or disposal, instant-on capabilities, dimmability, and the lack of audible noise. The inventors of the present invention believe, however, that current LED lighting sources themselves have significant drawbacks that cause consumers to be reluctant to using them.

A key drawback with current LED lighting sources is that the light output (e.g. lumens) is relatively low. Although current LED lighting sources draw a significantly lower amount of power than their incandescent equivalents (e.g. 5-10 watts v. 50 watts), they are believe to be far too dim to be used as primary lighting sources. As an example, a typical 5 watt LED lamp in the MR16 form factor may provide 200-300 lumens, whereas a typical 50 watt incandescent bulb in the same form factor may provide 700-1000 lumens. As a result, current LEDs are often used only for exterior accent lighting, closets, basements, sheds or other small spaces.

Another drawback with current LED lighting sources includes that the upfront cost of the LED is often shockingly high to consumers. For example, for floodlights, a current 30 watt equivalent LED bulb may retail for over $60, whereas a typical incandescent floodlight may retail for $12. Although the consumer may rationally “make up the difference” over the lifetime of the LED by the LED consuming less power, the inventors believe the significantly higher prices greatly suppress consumer demand. Because of this, current LED lighting sources do not have the price or performance that consumers expect and demand.

Additional drawbacks with current LED lighting sources includes they have many parts and are labor intensive to produce. As merely an example, one manufacturer of an MR16 LED lighting source utilizes over 14 components (excluding electronic chips), and another manufacturer of an MR 16 LED lighting source utilizes over 60 components. The inventors of the present invention believe that these manufacturing and testing processes are more complicated and more time consuming, compared to manufacturing and testing of a LED device with fewer parts and a more modular manufacturing process.

Additional drawbacks with current LED lighting sources, are that the output performance is limited by heat sink volume. More specifically, the inventors believe for replacement LED light sources, such as MR16 light sources, current heat sinks are incapable of dissipating very much heat generated by the LEDs under natural convection. In many applications, the LED lamps are placed into an enclosure such as a recessed ceiling that already have an ambient air temperatures to over 50 degrees C. At such temperatures the emissivity of surfaces play only a small roll of dissipating the heat. Further, because conventional electronic assembly techniques and LED reliability factors limit PCB board temperatures to about 85 degrees C., the power output of the LEDs is also greatly constrained. At higher temperatures, the inventors have discovered that radiation plays much more important role thus high emissivity for a heat sink is desirable.

Traditionally, light output from LED lighting sources have been increased by simply increasing the number of LEDs, which has lead to increased device costs, and increased device size. Additionally, such lights have had limited beam angles and limited outputs.

The inventor of the present invention has also recognized that costs for selling lighting sources also include the costs of inventory. More specifically, as different models of lighting sources are designed, e.g. wide spotlight, medium spotlight, tight spotlight) the manufacturer, distributor, and/or reseller have to make, sell and stock these different models. Because of this, a large amount of capital tends to be tied up in inventory and carrying costs, and not spent on innovation.

Accordingly, what is desired is a highly efficient lighting source without the drawbacks described above.

### SUMMARY

The present invention relates to high efficient lighting sources. More specifically, the present invention relates to a novel LED lighting source and methods of manufacturing thereof. Some general goals include, to increase light output without increasing device cost or device size, to enable coverage of many beam angles, and to provide a high reliability product for long life (ROI).

Embodiments of the present invention utilize primary and secondary optics to determine the properties of the output light. Often, the primary optics includes a reflective optic and the secondary optic includes a transmissive optic (e.g. a lens). In some embodiments, the ultimate output beam angle, beam shape, beam transitions (e.g. falloff), and the like determined by the secondary optic.

In various embodiments of the present invention a user receives one or more partially-completed illumination sources from a manufacturer, distributor, or the like. The user selects one or more optical lenses for the partially-completed illumination sources such that the completed illumination sources achieve user desired light beam characteristics (e.g. angles, drop-off). Subsequently, the user couples the one or more optical lenses into the partially-completed illumination sources. The completed illumination sources, when powered, thus output light having the user-desired light beam characteristics. This enables the possibility of reducing the number of stock keeping units (SKUs) that have to be manufactured or inventoried. Accordingly, a single SKU can ship with a variety of secondary optics allowing the customer to determine which optic is to be installed in the field to match the desired application requirements.

According to one aspect of the invention, an illumination source configured to output light having a user-modifiable beam characteristic is disclosed. One device includes a LED light unit configured to provide a light output in response to an output driving voltage, and a driving module coupled to the LED light unit, wherein the driving module is configured to receive an input driving voltage and configured to provide the output driving voltage. One unit includes a heat sink coupled to the LED light unit, wherein the heat sink is configured to dissipate heat produced by the LED light unit and the driving module, and a reflector coupled to the heat sink, wherein the reflector is configured to receive the light output, and wherein the reflector is configure to output a light beam having a first beam characteristic. A source may include a lens coupled to the heat sink, wherein the lens is configured to receive the light beam having the first beam characteristic and wherein the lens is configured to output a light beam having a second beam characteristic. In some embodiments, the lens is selected by the user to achieve the second beam angle. In some embodiments, the lens is physically coupled to the heat sink by the user.

According to one aspect of the invention, a method for configuring a light source to provide a light beam having a user-selected beam characteristic is disclosed. One technique includes receiving a light source, wherein the light source includes: a LED light unit configured to provide a light output in response to an output driving voltage, a driving module coupled to the LED light unit, wherein the driving module is configured to receive an input driving voltage and is configured to provide the output driving voltage, a heat sink coupled to the LED light unit, wherein the heat sink is configured to dissipate heat produced by the LED light unit and the driving module, and a reflector coupled to the heat sink, wherein the reflector is configured to receive the light output, and wherein the reflector is configured to output a light beam having a first beam characteristic. A process includes receiving a user selection of a lens to achieve a second beam characteristic, wherein the lens is configured to receive the light beam having the first beam characteristic and wherein the lens is configured to output a light beam having the second beam characteristic. A method includes coupling the lens to the heat sink of the light source.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIGS. 1A-B illustrate various embodiments of the present invention;

FIGS. 2A-B illustrates modular diagrams according to various embodiments of the present invention;

FIGS. 3A-B illustrate an embodiment of the present invention;

FIGS. 4A-B illustrate various embodiments of the present invention.

### DETAILED DESCRIPTION

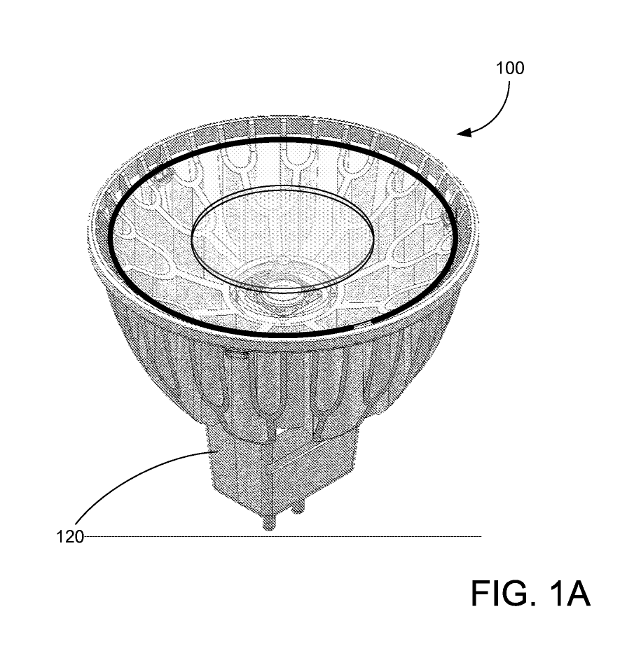

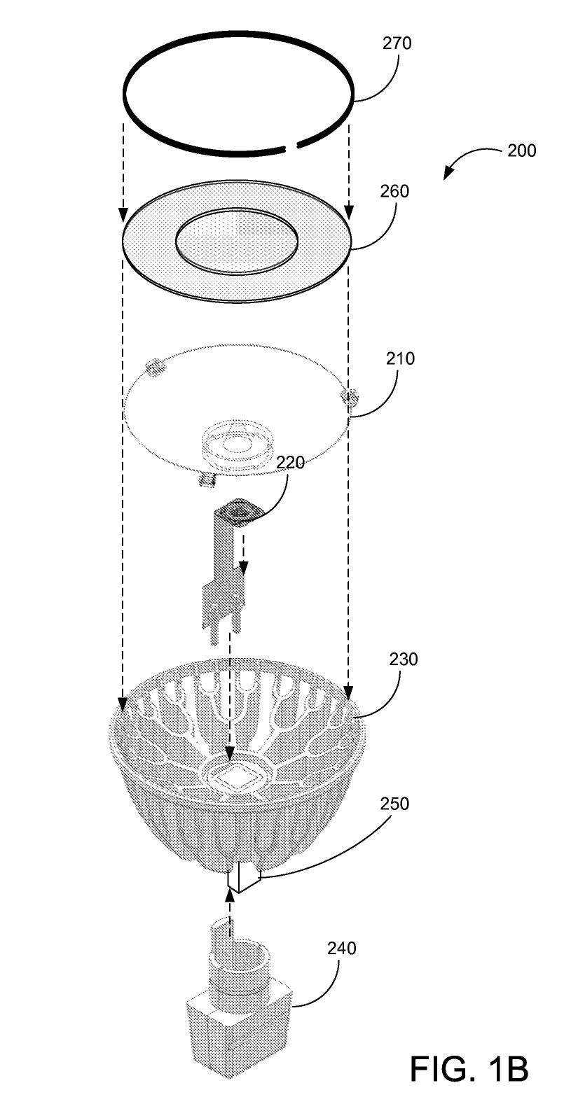

FIG. 1A illustrates an embodiment of the present invention. More specifically, FIG. 1A-B illustrate embodiments of MR-16 form factor compatible LED lighting source 100 having GU 5.3 form factor compatible base 120. MR-16 lighting sources typically operate upon 12 volts, alternating current (e.g. VAC). In the examples illustrated, LED lighting source 100 is configured to provide a spot light having a 10 degree beam size. In other embodiments, LED lighting sources may be configured to provide a flood light having a 25 or 40 degree beam size, or any other lighting pattern.

In various embodiments, an LED assembly described in the pending patent applications described above, and variations thereof, may be used within LED lighting source 100. These LED assemblies are currently under development by the assignee of the present patent application. In various embodiments, LED lighting source 100 may provide a peak output brightness of approximately 7600 to 8600 candelas (with approximately 360 to 400 lumens), a peak output brightness of approximately 1050 to 1400 candelas for a 40 degree flood light (with approximately 510 to 650 lumens), and a peak output of approximately 2300 to 2500 candelas for a 25 degree flood light (with approximately 620 to 670 lumens), and the like. Various embodiments of the present invention therefore are believed to have achieved the same brightness as conventional halogen bulb MR-16 lights.

FIG. 1B illustrates a modular diagram according to various embodiments of the present invention. As can be seen in FIG. 1B in various embodiments, light 200 includes a reflecting lens 210, an integrated LED module/assembly 220, a heat sink 230, a base housing 240, a transmissive lens 260, and a retainer 270. As will be discussed further below, in various embodiments, the modular approach to assembling light 200 is believed to reduce the manufacturing complexity, reduce manufacturing costs, and increase the reliability of such lights.

In various embodiments, reflecting lens 210 and transmissive lens 260 may be formed from a UV and resistant transparent material, such as glass, polycarbonate material, or the like. In various embodiments, reflecting lens 210 or transmissive lens 260 may be clear and transmissive or solid or coated and reflective. In the case of reflecting lens 210, the solid material creates a folded light path such that light that is generated by the integrated LED assembly 220 internally reflects within reflecting lens 210 more than one time prior to being output. Such a folded optic lens enables light 200 to have a tighter columniation of light than is normally available from a conventional reflector of equivalent depth. In the case of transmissive lens 260, the solid material may be clear or tinted, may be machined or molded, or the like to control the output characteristics of the light from reflecting lens 210.

In various embodiments, to increase durability of the lights, the optical materials should be operable at an elevated temperature (e.g. 120 degrees C.) for a prolonged period of time (e.g. hours). One material that may be used for reflecting lens 210 is known as Makrolon™ LED 2045 or LED 2245 polycarbonate available from Bayer Material Science AG. In other embodiments, other similar materials may also be used.

In FIG. 1B, reflecting lens 210 may be secured to heat sink 230 via one or more clips integrally formed on the edge of reflecting lens 210. In addition, reflecting lens 210 may also be secured via an adhesive proximate to where integrated LED assembly 220 is secured to heat sink 230. In various embodiments, separate clips may be used to restrain reflecting lens 210. These clips may be formed of heat resistant plastic material that is preferably white colored to reflect backward scattered light back through the lens.

In other embodiments, transmissive lens 260 may be secured to heat sink 230 via the clips described above. Alternatively, transmissive lens 260 may first be secured to a retaining ring 270, and retaining ring may be secured to one or more indents of heat sink 230, as will be illustrated below in greater detail. In some embodiments, once transmissive lens 260 and retaining ring 270 is secured to reflecting lens 210 or heat sink 230, they cannot be removed by hand. In such cases, one or more tools must be used to separate these components. In other embodiments, these components may be removed from reflecting lens 210 or heat sink 230 simply by hand.

In various embodiments of the present invention, LED assemblies may be binned based upon lumen per watt efficacy. For example, in some examples, an integrated LED module/assembly having a lumen per watt (L/W) efficacy from 53 to 66 L/W may be binned for use for 40 degree flood lights, a LED assembly having an efficacy of approximately 60 L/W may be binned for use for spot lights, a LED assembly having an efficacy of approximately 63 to 67 L/W may be used for 25 degree flood lights, and the like. In other embodiments, other classification or categorization of LED assemblies on the basis of L/W efficacy may used for other target applications.

In some embodiments, as will be discussed below integrated LED assembly/module 220 typically includes 36 LEDs arranged in series, in parallel series (e.g. three parallel strings of 12 LEDs in series), or the like. In other embodiments, any number of LEDs may be used, e.g., 1, 10, 16, or the like. In other embodiments, the LEDs may be electrically coupled in other manner, e.g. all series, or the like. Further details regarding such LED assemblies are provided in the patent application incorporated by reference above.

In various embodiments, the targeted power consumption for LED assemblies is less than 13 watts. This is much less than the typical power consumption of halogen based MR16 lights (50 watts). Accordingly, embodiments of the present invention are able to match the brightness or intensity of halogen based MR16 lights, but using less than 20% of the energy.

In various embodiments of the present invention, LED assembly 220 is directly secured to heat sink 230 to dissipate heat from the light output portion and/or the electrical driving circuits. In some embodiments, heat sink 230 may include a protrusion portion 250 to be coupled to electrical driving circuits. As will be discussed below, LED assembly 220 typically includes a flat substrate such as silicon or the like. In various embodiments, it is contemplated that an operating temperature of LED assembly 220 may be on the order of 125 to 140 degrees C. The silicon substrate is then secured to the heat sink using a high thermal conductivity epoxy (e.g. thermal conductivity ˜96 W/m.k.). In some embodiments, a thermoplastic/thermo set epoxy may be used such as TS-369, TS-3332-LD, or the like, available from Tanaka Kikinzoku Kogyo K.K. Other epoxies may also be used. In some embodiments, no screws are otherwise used to secure the LED assembly to the heat sink, however, screws or other fastening means may also be used in other embodiments.

In various embodiments, heat sink 230 may be formed from a material having a low thermal resistance/high thermal conductivity. In some embodiments, heat sink 230 may be formed from an anodized 6061-T6 aluminum alloy having a thermal conductivity k=167 W/m.k., and a thermal emissivity e=0.7. In other embodiments, other materials may be used such as 6063-T6 or 1050 aluminum alloy having a thermal conductivity k=225 W/m.k. and a thermal emissivity e=0.9. In other embodiments, still other alloys such AL 1100, or the like may be used. Additional coatings may also be added to increase thermal emissivity, for example, paint provided by ZYP Coatings, Inc. utilizing CR₂O₃ or CeO₂ may provide a thermal emissivity e=0.9; coatings provided by Materials Technologies Corporation under the brand name Duracon™ may provide a thermal emissivity e>0.98; and the like. In other embodiments, heat sink 230 may include other metals such as copper, or the like.

In some example, at an ambient temperature of 50 degrees C., and in free natural convection heat sink 230 has been measured to have a thermal resistance of approximately 8.5 degrees C./Watt, and heat sink 230 has been measured to have a thermal resistance of approximately 7.5 degrees C./Watt. With further development and testing, it is believed that a thermal resistance of as little as 6.6 degrees C./Watt are achievable in other embodiments. In light of the present patent disclosure, it is believed that one of ordinary skill in the art will be able to envision other materials having different properties within embodiments of the present invention.

In various embodiments, base assembly/module 240 in FIG. 1B provides a standard GU 5.3 physical and electronic interface to a light socket. As will be described in greater detail below, a cavity within base module 240 includes high temperature resistant electronic circuitry used to drive LED module 220. In various embodiments, an input voltage of 12 VAC to the lamps are converted to 120 VAC, 40 VAC, or other voltage by the LED driving circuitry. The driving voltage may be set depending upon specific LED configuration (e.g. series, parallel/series, etc.) desired. In various embodiments, protrusion portion 250 extends within the cavity of base module 240.

The shell of base assembly 240 may be formed from an aluminum alloy, and may formed from an alloy similar to that used for heat sink 230 and/or heat sink 230. In one example, an alloy such as AL 1100 may be used. In other embodiments, high temperature plastic material may be used. In some embodiments, instead of being separate units, base assembly 240 may be monolithically formed with heat sink 230.

As illustrated in FIG. 1B, a portion of the LED assembly 220 (silicon substrate of the LED device) contacts heat sink 230 in a recess within the heat sink 230. Additionally, another portion of the LED assembly 220 (containing the LED driving circuitry) is bent downwards and is inserted into an internal cavity of base module 240.

In various embodiments, to facilitate a transfer of heat from the LED driving circuitry to the shell of the base assemblies, and of heat from the silicon substrate of the LED device, a potting compound is provided. The potting compound may be applied in a single step to the internal cavity of base assembly 240 and to the recess within heat sink 230. In various embodiments, a compliant potting compound such as Omegabond® 200 available from Omega Engineering, Inc. or 50-1225 from Epoxies, etc., may be used. In other embodiments, other types of heat transfer materials may be used.

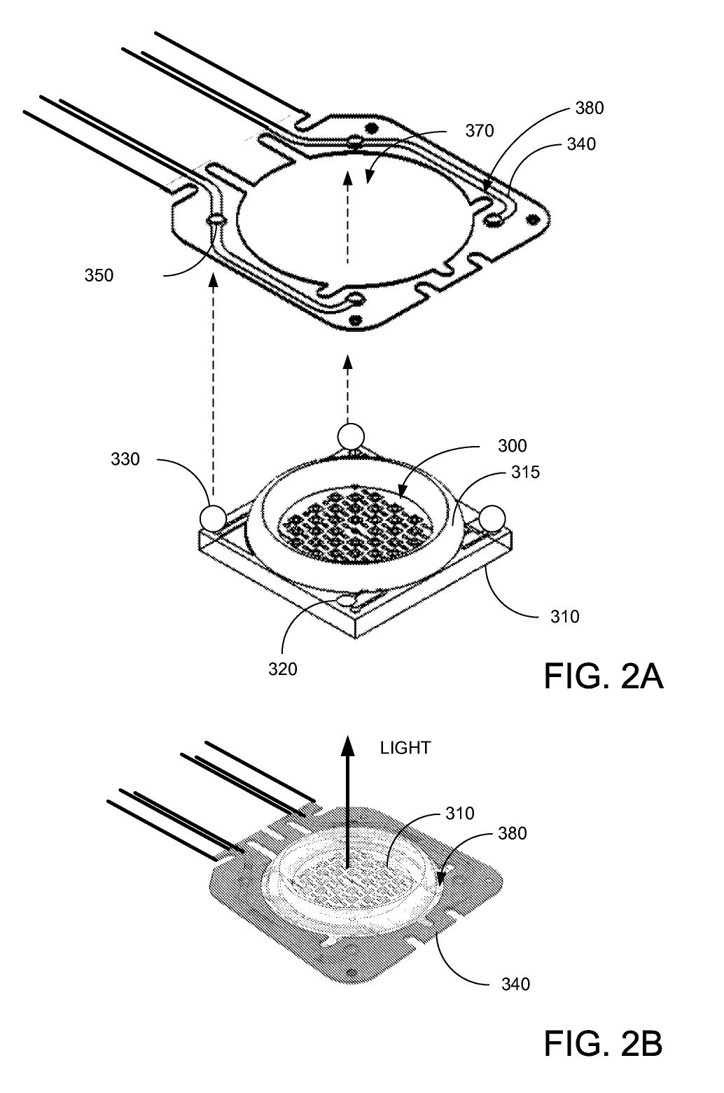

FIGS. 2A-B illustrate an embodiment of the present invention. More specifically, FIG. 2A illustrates an LED package subassembly (LED module) according to various embodiments. More specifically, a plurality of LEDs 300 are illustrated as being disposed upon a substrate 310. In some embodiments, it is contemplated that the plurality of LEDs 300 are connected in series and powered by a voltage source of approximately 120 volts AC (VAC). To enable a sufficient voltage drop (e.g. 3 to 4 volts) across each LED 300, in various embodiments 30 to 40 LEDs are contemplated to be used. In specific embodiments, 37 to 39 LEDs are coupled in series. In other embodiments, LEDs 300 are connected in parallel series and powered by a voltage source of approximately 40 VAC. For example, the plurality of LEDs 300 include 36 LEDs arranged in three groups each having 12 LEDs 300 coupled in series. Each group is thus coupled in parallel to the voltage source (40 VAC) provided by the LED driver circuitry, such that a sufficient voltage drop (e.g. 3 to 4 volts) is achieved across each LED 300. In other embodiments, other driving voltages are envisioned, and other arrangements of LEDs 300 are also envisioned.

In various embodiments, the LEDs 300 are mounted upon a silicon substrate 310, or other thermally conductive substrate. In various embodiments, a thin electrically insulating layer and/or a reflective layer may separate LEDs 300 and the silicon substrate 310. Heat produced from LEDs 300 is typically transferred to silicon substrate 310 and to a heat sink via a thermally conductive epoxy, as discussed above.

In various embodiments, silicon substrate is approximately 5.7 mm×5.7 mm in size, and approximately 0.6 microns in depth. The dimensions may vary according to specific lighting requirement. For example, for lower brightness intensity, fewer LEDs may be mounted upon the substrate, accordingly the substrate may decrease in size. In other embodiments, other substrate materials may be used and other shapes and sizes may also be used

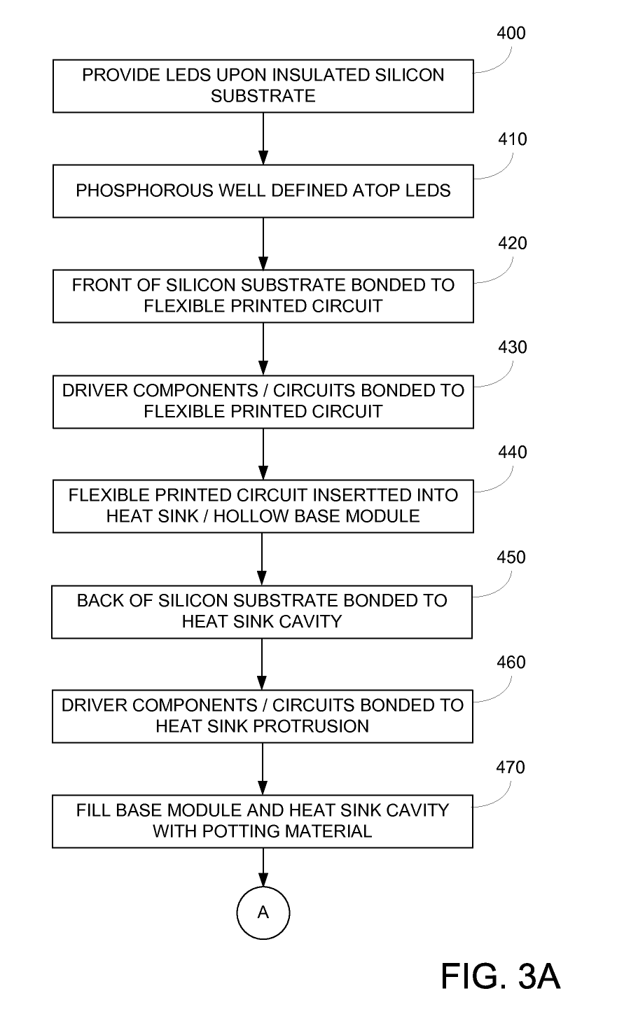

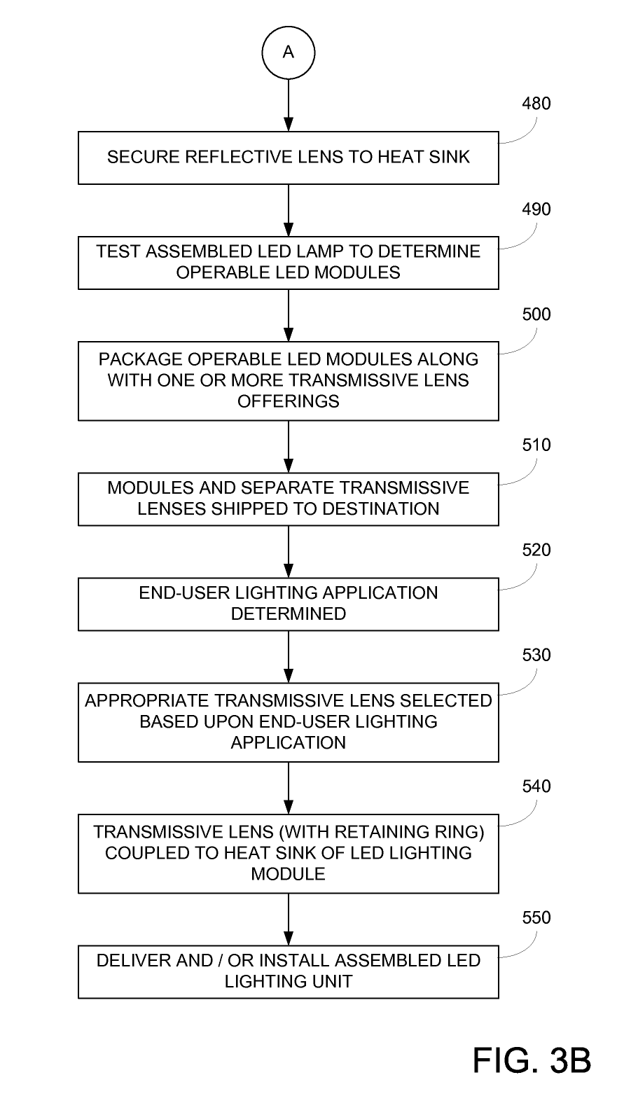

As shown in FIG. 3A, a ring of silicone (e.g., silicon dam 315) is disposed around LEDs 300 to define a well-type structure. In various embodiments, a phosphorus bearing material is disposed within the well structure. In operation, LEDs 300 provide a blue-ish light output, a violet, or a UV light output. In turn, the phosphorous bearing material is excited by the blue/uv output light, and emits white light output. Further details of embodiments of plurality of LEDs 300 and substrate 310 are described in the co-pending application incorporated by reference and referred to above.

As illustrated in FIG. 3A, a number of bond pads 320 may be provided upon substrate 310 (e.g. 2 to 4). Then, a conventional solder layer (e.g. 96.5% tin and 5.5% gold) may be disposed upon silicon substrate 310, such that one or more solder balls 330 are formed thereon. In the embodiments illustrated in FIG. 3A, four bond pads 320 are provided, one at each corner, two for each power supply connection. In other embodiments, only two bond pads may be used, one for each AC power supply connection.

Illustrated in FIG. 3A is a flexible printed circuit (FPC) 340. In various embodiments, FPC 340 may include a flexible substrate material such as a polyimide, such as Kapton™ from DuPont, or the like. As illustrated, FPC 340 may have a series of bonding pads 350, for bonding to silicon substrate 310, and bonding pads 360, for coupling to the high supply voltage (e.g. 120 VAC, 40 VAC, etc). Additionally, in some embodiments, an opening 370 is provided, through which LEDs 300 will shine through.

Various shapes and sizes for FPC 340 are contemplated in various embodiments of the present invention. For example, as illustrated in FIG. 3A, a series of cuts 380 may be made upon FPC 340 to reduce the effects of expansion and contraction of FPC 340 versus substrate 310. As another example, a different number of bonding pads 350 may be provided, such as two bonding pads. As merely another example, FPC 340 may be crescent shaped, and opening 370 may not be a through hole. In other embodiments, other shapes and sizes for FPC 340 are contemplated in light of the present patent disclosure.

In FIG. 2B, substrate 310 is bonded to FPC 340 via solder balls 330, in a conventional flip-chip type arrangement to the top surface of the silicon. By making the electrical connection at the top surface of the silicon, it is electrically isolated from the heat transfer surface of the silicon. This allows the entire bottom surface of the silicon substrate 310 to transfer heat to the heat sink. Additionally, this allows the LED to bonded directly to the heat sink to maximize heat transfer instead of a PCB material that typically inhibits heat transfer. As can be seen in this configuration, LEDs 300 are thus positioned to emit light through opening 370. In various embodiments, the potting compound discussed above is also used to serve as an under fill operation, or the like to seal the space (e.g., see cuts 380) between substrate 310 and FPC 340.

After the electronic driving devices and the silicon substrate 310 are bonded to FPC 340, the LED package sub assembly or module 220 is thus assembled. In various embodiments, these LED modules may then be individually tested for proper operation.

FIGS. 3A-B illustrate a block diagram of a manufacturing process according to embodiments of the present invention. In various embodiments, some of the manufacturing separate processes may occur in parallel or in series. For sake of understanding, reference may be given to features in prior figures.

In various embodiments, the following process may be performed to form an LED assembly/module. Initially, a plurality of LEDs 300 are provided upon an electrically insulated silicon substrate 310 and wired, step 400. As illustrated in FIG. 3A, a silicone dam 315 is placed upon the silicon substrate 310 to define a well, which is then filled with a phosphor-bearing material, step 410. Next, the silicon substrate 310 is bonded to a flexible printed circuit 340, step 420. As disclosed above, a solder ball and flip-chip soldering (e.g. 330) may be used for the soldering process in various embodiments.

Next, a plurality of electronic driving circuit devices and contacts may be soldered to the flexible printed circuit 340, step 430. The contacts are for receiving a driving voltage of approximately 12 VAC. As discussed above, unlike present state of the art MR-16 light bulbs, the electronic circuit devices, in various embodiments, are capable of sustained high-temperature operation, e.g. 120 degrees C.

In various embodiments, the second portion of the flexible printed circuit including the electronic driving circuit is inserted into the heat sink and into the inner cavity of the base module, step 440. As illustrated, the first portion of the flexible printed circuit is then bent approximately 90 degrees such that the silicon substrate is adjacent to the recess of the heat sink. The back side of the silicon substrate is then bonded to the heat sink within the recess of the heat sink using an epoxy, or the like, step 450.

In various embodiments, one or more of the heat producing the electronic driving components/circuits may be bonded to the protrusion portion of the heat sink, step 460. In some embodiments, electronic driving components/circuits may have heat dissipating contacts (e.g. metal contacts) These metal contacts may be attached to the protrusion portion of the heat sink via screws (e.g. metal, nylon, or the like). In some embodiments, a thermal epoxy may be used to secure one or more electronic driving components to the heat sink. Subsequently a potting material is used to fill the air space within the base module and to serve as an under fill compound for the silicon substrate, step 470.

Subsequently, a reflective lens may be secured to the heat sink, step 480, and the LED light source may then be tested for proper operation, step 490.

In various embodiments, the base sub-assembly/modules that operate properly may be packaged along with one or more transmissive lens offerings and/or a retaining ring (described above), step 500, and shipped to one or more distributors, resellers, retailers, or customers, step 510. In various embodiments, the modules and separate transmissive lenses may be stocked, stored, or the like.

Subsequently, in various embodiments, an end user desires a particular lighting solution, step 520. In various examples, the lighting solution may require different beam angles, different cut-off angles or roll-offs, different coloring, different field angles, and the like. In various embodiments, the beam angles, the field angles, and the full cutoff angles may vary from the above, based upon engineering and/or marketing requirements. Additionally, the maximum intensities may also vary based upon engineering and/or marketing requirements.

Based upon the end-user's application, a secondary transmissive lens may be selected, step 530. In various embodiments, the selected lens may or may not be part of a “kit” for the lighting module. In other words, in some examples, various transmissive lenses are provided with each lighting module; and in other examples, lighting modules are provided separately from the transmissive lenses.

In various embodiments, an assembly process may include attaching the retaining ring to a transmissive lens, and snapping the retaining ring into a groove of the heat sink, step 540. In other embodiments, a retaining ring is already installed for each transmissive lens that is provided.

In some embodiments, once the retaining ring is snapped into the heat sink, clips, or the like, the retaining ring (and secondary optic lens) cannot be removed by hand. In such cases, a tool, such as a thin screwdriver, pick, or the like, must be used to remove the secondary optic lens (transmissive lens) from the assembled unit. In other embodiments, the restraint mechanism may be removed by hand.

In FIG. 3B, the assembled lighting unit may be provided to the end-user and installed, step 550.

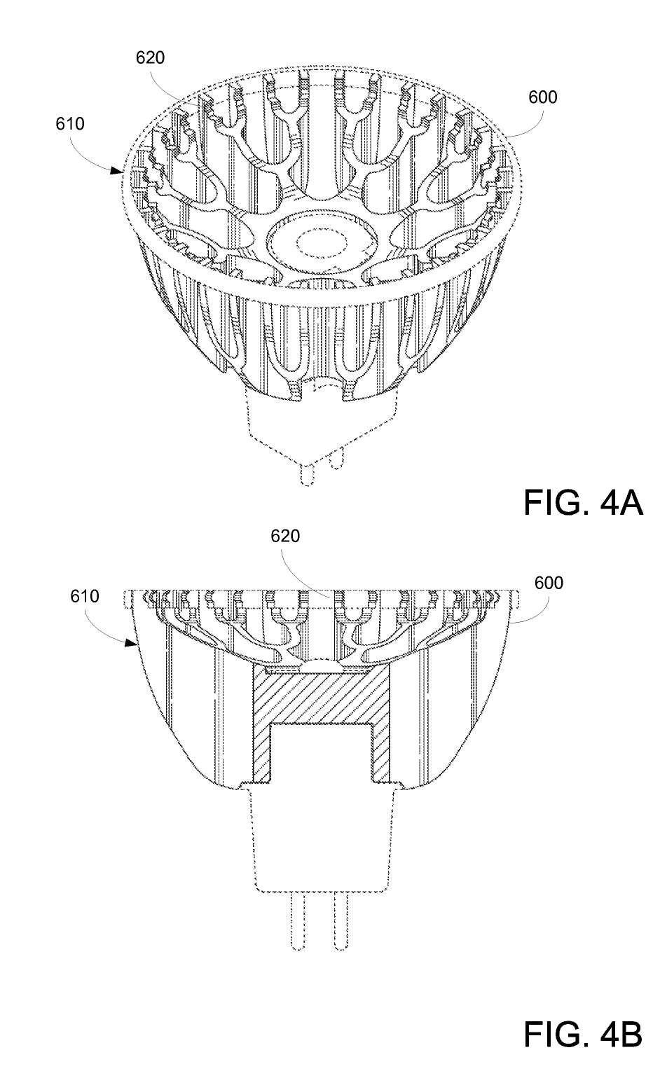

FIGS. 4A-B illustrate embodiments of a heat sink according to embodiments of the present invention. More specifically, FIG. 4A illustrates a perspective view of a heat sink, and FIG. 4B illustrates a cross-section view of the heat sink.

In FIGS. 4A-B, a heat sink 600 is illustrated including a number of heat dissipating fins 610. Additionally, fins 610 may include a mechanism for mating onto the retaining ring/transmissive lens. As illustrated in the example in FIGS. 4A-B, the mechanism includes indentations 620 on fins 610. In some embodiments, each of fins 610 may include indentation 620, whereas in other embodiments, less than all of fins 610 may include indentations. In other embodiments, the mating mechanism may include the use of an additional clip, a clip on the reflective optics, or the like.

In other embodiments, the transmissive lens may be coupled to a an intermediate grille, or the like that is coupled to the heat sink and/or reflective lens. Accordingly, embodiments of the present invention may be directed towards wide-beam light sources or narrow-beam light sources.

Further embodiments can be envisioned to one of ordinary skill in the art after reading this disclosure. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope.

What is claimed is:

1. An illumination source configured to output light having a user-modifiable beam characteristic comprising:
a LED light unit configured to provide a light output in response to an output driving voltage;
a driving module coupled to the LED light unit, wherein the driving module is configured to receive an input driving voltage and is configured to provide the output driving voltage;
a heat sink coupled to the LED light unit, wherein the heat sink is configured to dissipate heat produced by the LED light unit and by the driving module;
a reflector coupled to the heat sink, wherein the reflector is configured to receive the light output, and wherein the reflector is configured to output a light beam having a first beam characteristic; and
a lens coupled to the heat sink, wherein the lens is configured to receive the light beam having the first beam, and wherein the lens is configured to output a light beam having a second beam characteristic;
wherein the lens is selected by the user to achieve the second beam characteristic; and
wherein the lens is coupled to the heat sink by the user.

2. The illumination source of claim 1 wherein the lens comprises:
a transmissive optical lens; and
a retaining ring coupled to the transmissive optical lens, wherein the retaining ring is configured to couple the transmissive optical lens to the heat sink.

3. The illumination source of claim 2 wherein the retaining ring consists of an incomplete circle.

4. The illumination source of claim 1 wherein the lens that is coupled to the heat sink is configured to require use of a tool to decouple the lens from the heat sink.

5. The illumination source of claim 1 wherein an intensity for the light output is greater than approximately 1500 candela.

6. The illumination source of claim 1 wherein the first beam characteristic is selected from a group consisting of: beam angle, cut-off angles, roll-offs characteristic, and field angle.

7. The illumination source of claim 1
wherein the heat sink comprises a plurality of heat dissipation fins;
wherein at least one of the plurality of heat dissipation fins includes a retaining mechanism; and
wherein the lens is configured to be coupled to the at least one heat dissipation fin via the retaining mechanism.

8. The illumination source of claim 7 wherein the retaining mechanism is selected from a group consisting of: an indentation on the heat dissipation fin, and a clip coupled to the heat dissipation fin.

9. The illumination source of claim 1 wherein the heat sink comprises an MR16 form factor heat sink.

10. The illumination source of claim 1 wherein the driving module comprises a GU5.3 compatible base.

11. A method for configuring a light source to provide a light beam having a user-selected beam characteristic comprising:
receiving a light source, wherein the light source comprises:
a LED light unit configured to provide a light output in response to an output driving voltage;
a driving module coupled to the LED light unit, wherein the driving module is configured to receive an input driving voltage and is configured to provide the output driving voltage;
a heat sink coupled to the LED light unit, wherein the heat sink is configured to dissipate heat produced by the LED light unit and by the driving module; and
a reflector coupled to the heat sink, wherein the reflector is configured to receive the light output, and wherein the reflector is configured to output a light beam having a first beam characteristic;
receiving a user selection of a lens to achieve a second beam characteristic, wherein the lens is configured to receive the light beam having the first beam characteristic and wherein the lens is configured to output a light beam having the second beam characteristic;
receiving the lens in response to the user selection of the lens, separate from the light source; and
coupling the lens to the light source.

12. The method of claim 11
wherein the lens comprises:
an optical lens; and
a retaining ring coupled to the optical lens, wherein the retaining ring is configured to couple the optical lens to the heat sink; and
wherein coupling the lens to the heat sink comprises:
compressing the retaining ring about the optical lens;
disposing the retaining ring that is compressed within a portion of the heat sink; and
releasing the retaining ring such that the retaining ring is coupled to the portion of the heat sink.

13. The method of claim 12 wherein the retaining ring comprises a circular shaped metal.

14. The method of claim 11 further comprising:
decoupling the lens from the heat sink using a tool;
wherein the decoupling step requires use of a tool to decouple the lens from the heat sink.

15. The method of claim 11 wherein an intensity for the light output is greater than approximately 1500 candela.

16. The method of claim 11 wherein the first beam characteristic is selected from a group consisting of: beam angle, cut-off angles, roll-offs characteristic, and field angle.

17. The method of claim 11
wherein the heat sink comprises a plurality of heat dissipation fins;
wherein at least one of the plurality of heat dissipation fin includes a retaining mechanism, and
wherein coupling the lens to heat sink comprises coupling the lens to the at least one heat dissipation fin via the retaining mechanism.

18. The method of claim 17 wherein the retaining mechanism is selected from a group consisting of: an indentation on the heat dissipation fin, and a clip coupled to the heat dissipation fin.

19. The method of claim 11 wherein the heat sink comprises an MR16 form factor heat sink.

20. The method of claim 11 wherein the driving module comprises a GU5.3 compatible base.
